(19) United States
(12) Patent Application Publication
(10) Pub. No.: US 2015/0354503 A1
(43) Pub. Date: Dec. 10, 2015

(54) SYSTEM AND A METHOD FOR FEEDING A ROCKET ENGINE

(71) Applicant: SNECMA, Paris (FR)

(72) Inventors: Didier VUILLAMY, Quincampoix (FR); Gérard ROZ, Pressagny L'orgueilleux (FR)

(73) Assignee: SNECMA, Paris (FR)

(21) Appl. No.: 14/760,186

(22) PCT Filed: Jan. 8, 2014
(86) PCT No.: PCT/FR2014/050024

§ 371 Date: Jul. 9, 2015

(30) Foreign Application Priority Data
Jan. 11, 2013 (FR) 1350240

(51) Int. Cl. F02K 9/46; F02K 9/52; F02K 9/60

(52) U.S. Cl. CPC F02K 9/46; F02K 9/60; F02K 9/52

(57) ABSTRACT

The invention relates to the field of rocket engines, and more particularly to a system for feeding a rocket engine (2) with propellant, the system comprising a first tank (3), a second tank (4), a first feed circuit (6) connected to the first tank (3), and a second feed circuit (7) connected to the second tank (4). In order to cool the propellant contained in the second tank (4), the first circuit (6) includes a branch (12) passing through a first heat exchanger (14) incorporated in the second tank (4). The invention also provides a method of feeding the rocket engine (2).

### BACKGROUND OF THE INVENTION

The present invention relates to the field of feeding liquid propellants to a rocket engine.

In the description below, the terms “upstream” and “downstream” are defined relative of the normal flow direction of propellants in the feed circuits of a rocket engine.

A system for feeding a rocket engine with liquid propellant typically comprises, for each liquid propellant, a tank and a feed circuit connected to the tank in order to transfer the propellant from the tank to at least one thrust chamber in which the propellants are mixed and burnt in order to generate thrust in reaction to the combustion gas accelerating in a nozzle.

During the operation of such a rocket engine, the liquid content empties progressively from each propellant tank. In order to ensure that each propellant flows through the feed circuit to the thrust chamber, it is necessary to keep the pressure inside each tank above a minimum threshold. In the prior art, various alternatives are known for ensuring that tanks remain pressurized while they are emptying, however those alternatives present various drawbacks in terms of weight and complexity.

Furthermore, it is also often important to avoid any excessive rise in the pressure inside each tank, in particular in order to avoid the tank bursting. Nevertheless, at least when the propellants are cryogenic propellants, it is difficult to avoid the liquid propellants in the tanks evaporating gradually as a result of absorbing heat through the walls of the tanks, which evaporation leads to the pressure in the tanks rising. Attempting to solve that problem by increasing thermal insulation of the tanks nevertheless leads to major drawbacks, and in particular to a large increase in their weight.

In addition, the gradual heating of the propellants in the tanks involves other drawbacks. In particular, the increase in the saturation pressure of each propellant as it heats up reduces the cavitation margins in the pumps downstream from the tanks and thus increases the risk of cavitation phenomena occurring in the pumps.

### OBJECT AND SUMMARY OF THE INVENTION

The systems and methods in the present description seek to remedy those drawbacks. In particular, the present description relates to a system for feeding a rocket engine with propellants, the system comprising a first tank, a second tank, and a first feed circuit connected to the first tank, which first feed circuit enables a second liquid propellant extracted from the second tank to be cooled, in particular for the purpose of compensating any gradual heating of the second propellant in the tank.

In at least one embodiment, this object is achieved by the fact that the first circuit also includes a branch passing through a first heat exchanger incorporated in the second tank, said branch being connected to the first tank downstream from said first heat exchanger.

By means of these provisions, with a second liquid propellant having a saturation point that is substantially higher than that of the first liquid propellant, it is possible in the first heat exchanger to transfer heat from the second propellant to the first propellant so as to cause the first propellant bled through the branch to pass into the gaseous state while cooling the second propellant. Furthermore, the flow of the first propellant bled through the branch can thus be reinjected into the first tank and, since it is in the gaseous state, it then contributes to maintaining the pressure inside the first tank while it is emptying.

In a second aspect, said feed system also includes a second feed circuit connected to the second tank and including a pump. The cooling of the second propellant in the second tank by means of the first heat exchanger helps avoid cavitation phenomena in the pump of the second feed circuit.

In a third aspect, said branch may also include a bypass duct bypassing said first heat exchanger. This bypass duct, which may include a flow rate regulator valve, enables a portion of the first propellant bled through the branch to bypass at least said first heat exchanger. On subsequently mixing with the first propellant leaving the first heat exchanger, it enables its temperature to be reduced before being reinjected into the first tank. In particular, if this bypass duct includes a flow rate regulator valve, it thus becomes possible to regulate more accurately the variation in the pressure of the first propellant in the first tank.

In order to ensure the return flow of the first propellant to the first tank via said branch, this branch may be situated downstream from a pump that also forms part of the first feed circuit. This pump can thus also serve to cause the first propellant to flow simultaneously to the thrust chamber, and by way of example it may be an electric pump or a turbopump. Nevertheless, the feed circuit could alternatively be configured so as to ensure that the first propellant flows to the thrust chamber by other means, such as for example by pressurization from an upstream tank. In order to ensure the return flow of the first propellant to the first tank through this branch even under such circumstances, the branch may itself include a forced flow device for acting on the first propellant.

In a fourth aspect, said first heat exchanger may be incorporated in an outlet funnel from the second tank, so as to cool more particularly the second propellant as it leaves the second tank, thereby acting more effectively to eliminate cavitation phenomena in any pump connected downstream.

In a fifth aspect, the first circuit may also include at least one second heat exchanger incorporated in the second tank so as to provide better cooling of the second propellant leaving the second tank. In particular, this second heat exchanger may also be incorporated in an outlet funnel from the second tank, possibly in the same funnel as the first heat exchanger. In addition, said first circuit may also include a third heat exchanger incorporated in the second tank, upstream from the second heat exchanger, in order to cool the second propellant in the second tank and thus compensate for it being heated gradually by absorbing heat through the walls of the second tank, thereby avoiding any excessive rise of pressure inside the second tank. In particular, when the saturation temperature of the second propellant in the second tank is considerably higher than the saturation temperature of the first propellant in the first circuit, these second and third heat exchangers may provide a large amount of additional cooling without the first propellant that passes through these heat exchangers necessarily passing into the gaseous phase.

In a sixth aspect, the first feed circuit may further include, upstream from said return branch, another heat exchanger suitable for being connected to a heat source, such as, for example, a fuel cell, a battery, or an electronic circuit, thereby enabling it to be cooled.

The present description also relates a method of feeding a rocket engine with liquid propellants, the method comprising the following steps: extracting a flow of a first liquid propellant from a first tank through a first feed circuit, bleeding a portion of said flow of the first liquid propellant through a branch of the first feed circuit, passing the first liquid propellant bled through said branch into the gaseous state in a heat exchanger incorporated in a second tank containing a second liquid propellant at a temperature higher than the saturation temperature of the first liquid propellant in the branch, and extracting a flow of the second liquid propellant from the second tank via a second feed circuit. Optionally, at least a portion of the first propellant bled through said branch may be reinjected, in the gaseous state, into the first tank. The first liquid propellant may be liquid hydrogen and the second liquid propellant may be liquid oxygen.

### BRIEF DESCRIPTION OF THE DRAWINGS

The invention can be well understood and its advantages appear better on reading the following detailed description of various embodiments shown as non-limiting examples. The description refers to the accompanying drawings, in which:

FIG. 1 is a diagram of a vehicle comprising a rocket engine with a feed system in a first embodiment;

FIG. 2 is a diagram of an outlet funnel from a propellant tank of the FIG. 1 feed system;

FIG. 3 is a diagram of a vehicle comprising a rocket engine with a feed system in a second embodiment;

FIG. 4 is a diagram of an outlet funnel from a propellant tank of the FIG. 3 feed system;

FIG. 5 is a diagram of a vehicle comprising a rocket engine with a feed system in a third embodiment;

FIG. 6 is a diagram of a vehicle comprising a rocket engine with a feed system in a fourth embodiment;

FIG. 7 is a diagram of a vehicle comprising a rocket engine with a feed system in a fifth embodiment;

FIG. 8 is a diagram of a vehicle comprising a rocket engine with a feed system in a sixth embodiment; and

FIG. 9 is a diagram of a vehicle comprising a rocket engine with a feed system in a seventh embodiment.

### DETAILED DESCRIPTION OF THE INVENTION

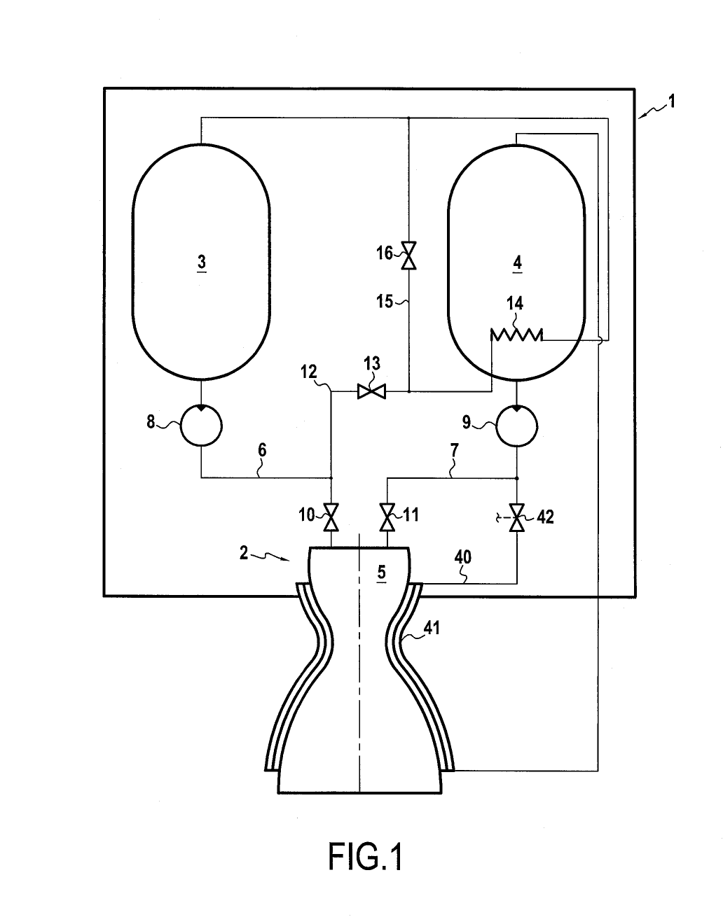

A vehicle 1, which might for example be a stage of a space launcher, is shown diagrammatically in FIG. 1. For its propulsion, this vehicle 1 has a liquid propellant rocket engine 2 with a feed system comprising a first tank 3 for a first propellant, a second tank 4 for a second propellant, a thrust chamber 5 for combustion of a mixture of the two propellants and for accelerating the combustion gas from the mixture, a first feed circuit 6 connected to the base of the first tank 3 and to the thrust chamber 5 in order to supply it with the first propellant, and a second feed circuit 7 connected to the base of the second tank 4 to the thrust chamber 5 in order to supply it with the second propellant. These first and second propellants may be cryogenic propellants such as liquid hydrogen and liquid oxygen, or they may be other liquid propellants, but under all circumstances the saturation temperature of the second propellant in the second tank 4 is substantially higher than the saturation temperature of the first propellant in the first circuit 6 downstream from the pump 8. Each of the feed circuits 6, 7 has a respective pump 8, 9 for driving the respective propellant through each of the feed circuits 6, 7, and outlet vales 10, 11 for opening and closing the flow of propellant to the thrust chamber 5. By way of example, the pumps 8, 9 may be electric pumps, or they may be turbopumps.

Downstream from the pump 8, the first feed circuit 6 has a return branch 12 returning to the top of the first tank 3. This return branch includes a valve 13 and a first heat exchanger 14 incorporated in the second tank 4. In addition, this return branch also includes, downstream from the valve 13, a bypass duct 15 including a valve 16 and serving to bypass the first heat exchanger 14. The valves 13 and 16 may be variable flow rate valves, thus enabling variations in the flow rates through the branch 12 and the bypass duct 15 to be regulated accurately.

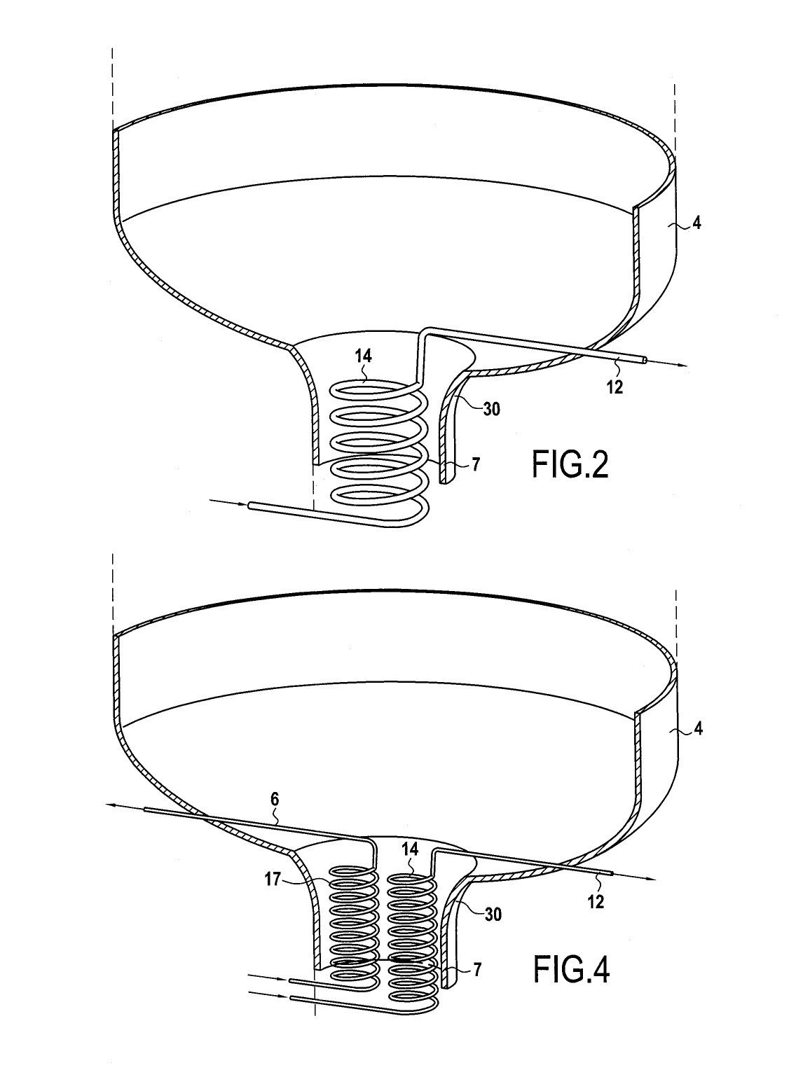

The heat exchanger 14 is adjacent to the connection of the second tank 4 to the second circuit 7. More specifically, as shown in FIG. 2, the heat exchanger 14 is incorporated in an outlet funnel 30 from the second tank 4 leading to the second circuit 7, so as to facilitate transferring heat from the flow of the second propellant leaving the second tank 4 to the flow of the first propellant flowing through the heat exchanger.

Downstream from the pump 9 (see FIG. 1), the second circuit 7 also includes a return branch 40 returning to the top of the second tank 4, passing through another heat exchanger 41 arranged around the thrust chamber 5 so as to be heated by radiation therefrom. Upstream from the heat exchanger 41, this branch 40 also includes a valve 42, which may be a variable flow rate valve, thereby enabling the flow through the branch 40 to be regulated accurately.

In operation, while the two pumps 8 and 9 are pumping the two propellants from the respective tanks 3 and 4, and through the respective feed circuits 6 and 7 to the thrust chamber 5, a portion of the flow of the first propellant is bled from the first circuit 6 via the branch 12.

The bleed flow is regulated by the valve 13, which may be controlled by a control unit (not shown) as a function of various kinds of physical data provided by sensors (not shown), such as, for example, pressure and temperature sensors in the two tanks 3 and 4.

A portion of this bleed flow passes through the heat exchanger 14 where it is heated by the second propellant, thus causing it to pass into the gaseous phase. Another portion of this bleed flow, regulated by the valve 16, nevertheless bypasses the heat exchanger 14 via the duct 15 and subsequently rejoins the remainder of the bleed flow downstream from the heat exchanger 14. The valve 16 of the bypass duct 15, as controlled by the control unit as a function of the data from the sensors, thus enables the temperature of the bleed flow of the first propellant to be regulated prior to it being reinjected into the first tank 3, serving in particular to avoid reinjecting it at a temperature that is too high. The reinjection of this bleed flow in the gaseous state nevertheless serves to occupy the volume left empty by the first propellant feeding the thrust chamber 5, thereby maintaining pressure inside the first tank 3.

Simultaneously, the transfer of heat in the heat exchanger 14 cools the flow of the second propellant that is taken from the second tank 4 through the funnel 30. Thus, the flow of the second propellant that reaches the pump 9 is substantially cooled, thereby serving to reduce cavitation phenomena in the pump 9. This cooling of the second propellant taken from the second tank 4 thus provides a greater margin for temperature fluctuation of the second propellant in the second tank 4.

Thus, by way of example, for a rocket engine 2 fed with liquid hydrogen and liquid oxygen and delivering a thrust F of 2 kilonewtons (kN), the transition into the gas phase in the heat exchanger 14 of the bleed flow of liquid hydrogen Q_{LH2} for pressurizing the first tank 3 absorbs heat power Pᵥ of the order of 1 kilowatt (kW). The flow rate of liquid oxygen Q_{LOX} taken from the second tank 4 through the funnel 30 in order to feed the thrust chamber is of the order of 0.4 kilograms per second (kg/s), so its temperature T_{LOX} is reduced by about 1.5 kelvin (K), which corresponds to a drop in its saturation pressure P_{LOX,sat} lying in the range 30 kilopascals (kPa) to 40 kPa.

Simultaneously, a portion of the flow of the second propellant taken from the second tank 4 through the funnel 30 and the second circuit 7 is bled via the branch 40 and heated in the heat exchanger 41 by heat radiation from the thrust chamber 5, so as to pass into the gaseous phase prior to being injected into the second tank 4, in order to maintain internal pressure therein. This flow rate is regulated by the valve 42, which may also be controlled by the above-mentioned control unit as a function of physical data supplied by sensors such as, for example, pressure and temperature sensors in the two tanks 3 and 4.

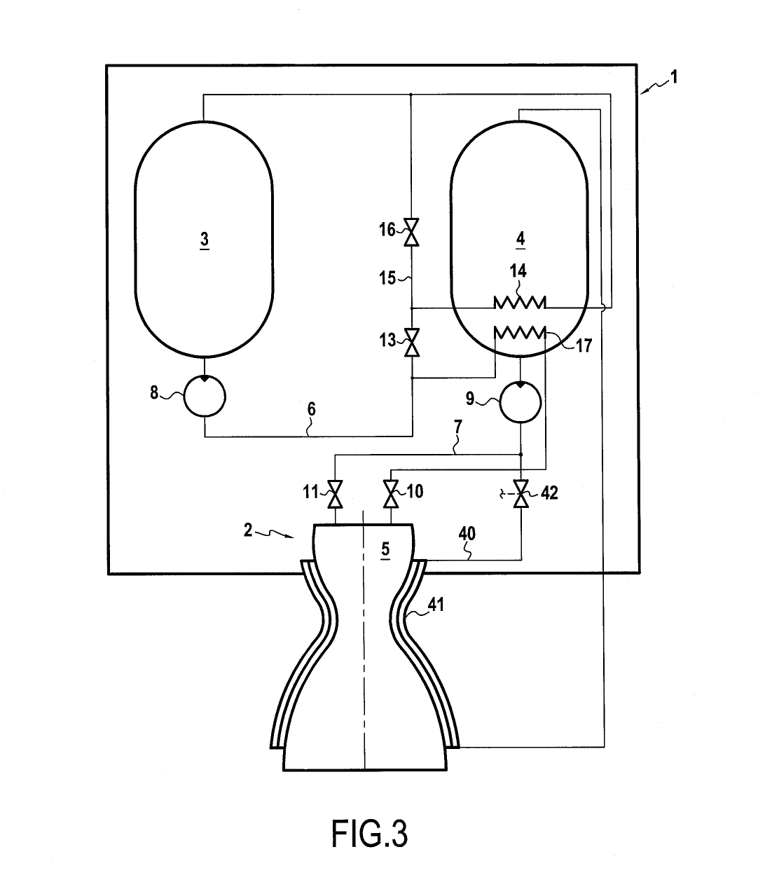

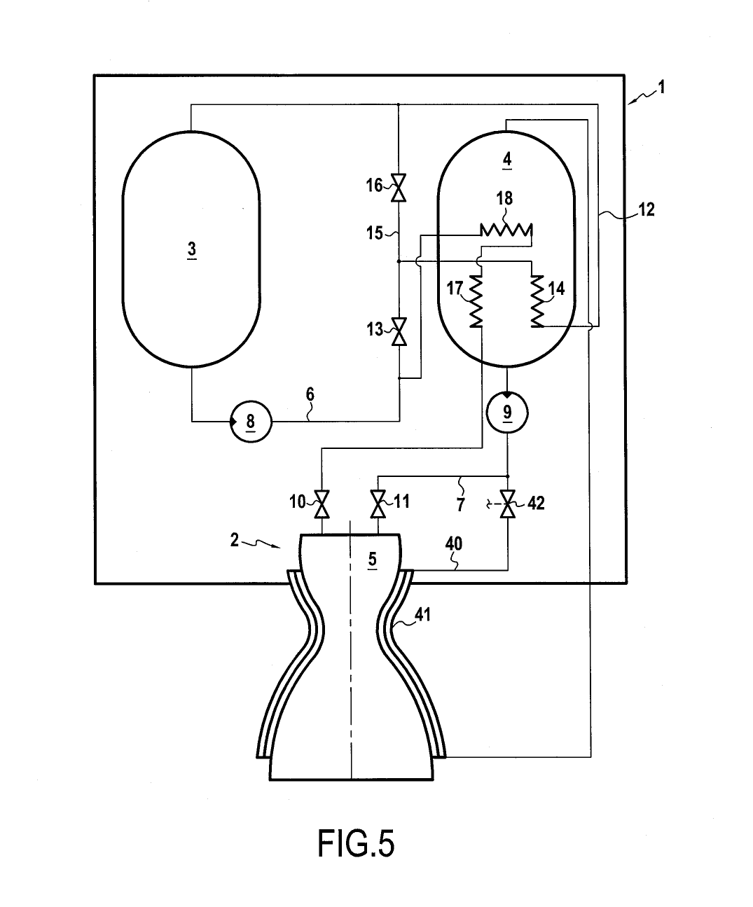

A vehicle 1 in a second embodiment is shown in FIG. 3. The feed system for the rocket engine 2 of this vehicle 1 differs from the system of the first embodiment in that it includes a second heat exchanger 17 in the first feed circuit 6. The other elements of this vehicle 1 are essentially equivalent to those of the first embodiment, and they are given the same reference numbers. This second heat exchanger 17 forms a portion of the segment of the first feed circuit 6 that leads finally into the thrust chamber 5. As shown in FIG. 4, it is also adjacent to the connection of the second tank 4 to the second circuit 7, and more specifically it is incorporated in the outlet funnel 30 from the second tank 4 to the second circuit 7, like the first heat exchanger 14, so as to facilitate heat transfer from the flow of the second propellant leaving the second tank 4 to the flow of first propellant flowing through the second heat exchanger 17.

In operation, the flow of the first propellant as bled via the branch 15 serves to pressurize the first tank in the same manner as in the first embodiment. Nevertheless, simultaneously, the flow of the first propellant that is not bled through the branch 15, but that continues to flow through the first circuit 6 to the thrust chamber 5 also contributes to cooling the second propellant by heat transfer in the second heat exchanger 17. This additional cooling serves to reinforce the advantages of cooling the second propellant by means of the first heat exchanger 14.

A vehicle 1 in a third embodiment is shown in FIG. 5. The feed system of the rocket engine 2 in this other vehicle 1 differs from that of the second embodiment in that it includes a third heat exchanger 18 directly upstream from the second heat exchanger 17 in the first feed circuit 6. The other elements of this vehicle 1 are essentially equivalent to those of the second embodiment, and they are given the same reference numbers.

Like the first and second heat exchangers 14 and 17, this third heat exchanger 18 is also incorporated in the second tank 4. Nevertheless, unlike the other two heat exchangers 14 and 17, it is not incorporated in the funnel 30, but above it, so as to provide better cooling of the second propellant in the core of the second tank 4 and so as to provide better compensation for it being heated by absorbed heat through the walls of the second tank 4.

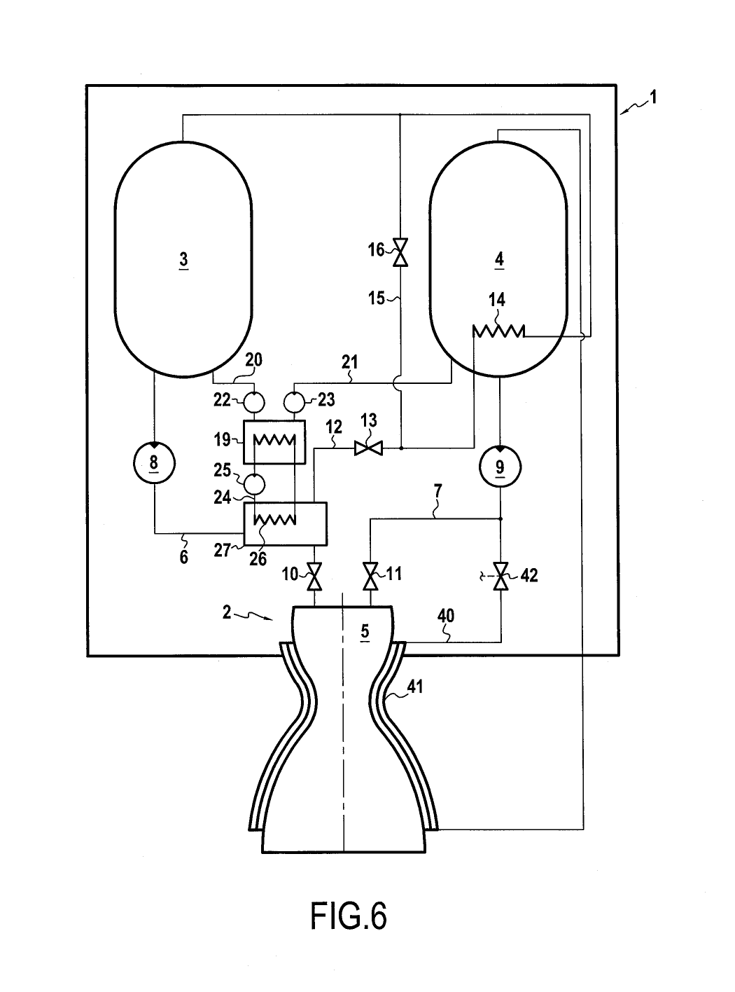

A vehicle 1 in a fourth embodiment is shown in FIG. 6. This other vehicle 1 differs from that of the first embodiment in that it also has a fuel cell 19 that is connected to the tanks 3 and 4 via respective feed circuits 20 and 21 fitted with respective micropumps 22 and 23. The circuits 20, 21 thus serve to feed the fuel cell 19 with a fraction of the propellant contained in the tanks 3 and 4, in order to generate electricity for providing electrical power to equipment on board the vehicle 1. Since the chemical reaction of the propellants in the fuel cell 19 also normally generates heat that can disturb its operation if it is not discharged correctly, the fuel cell 19 is also fitted with a cooling circuit 24 having a forced flow device 25. Because of the internal pressure of the tanks 3 and 4, the micropumps 22 and 23 may nevertheless possibly be replaced by variable flow rate valves, it being possible for the internal pressure in the tanks 3 and 4 to suffice for ensuring that the propellants flow to the fuel cell 19.

The cooling circuit 24 contains a cooling fluid, such as helium for example, and the forced flow device 25 causes this fluid to flow in order to transfer heat from the fuel cell 19 to a heat exchanger 26. Nevertheless, as an alternative, other means for causing the cooling fluid to flow in the circuit 24 could be envisaged, such as a thermosiphon, for example. This other heat exchanger 26 is incorporated in the first feed circuit 6 of the rocket engine 2 in such as a manner as to transfer this heat to the first propellant. In the embodiment shown, this other heat exchanger 26 is incorporated in a buffer tank 27 upstream from the branch 12, with the volume of the first propellant that is contained in this buffer tank 27 providing a large capacity for absorbing heat, even when the flow of the first propellant in the circuit 6 is stopped. A volume Vₜ of 30 liters (L) of liquid hydrogen in the buffer tank 27 can thus absorb a heat power P_{c} of 100 watts (W) for one hour with the temperature rise ΔT of the liquid hydrogen being only 17 K. It is nevertheless possible to envisage other arrangements of the heat exchanger 26 in the first circuit 6. The other elements of this vehicle 1 are essentially equivalent to those of the first embodiment, and they are given the same reference numbers.

In these four embodiments, although the propellants are caused to flow to the thrust chamber by means of pumps, it is also possible to envisage using alternative means, such as for example pressurizing the propellant tank.

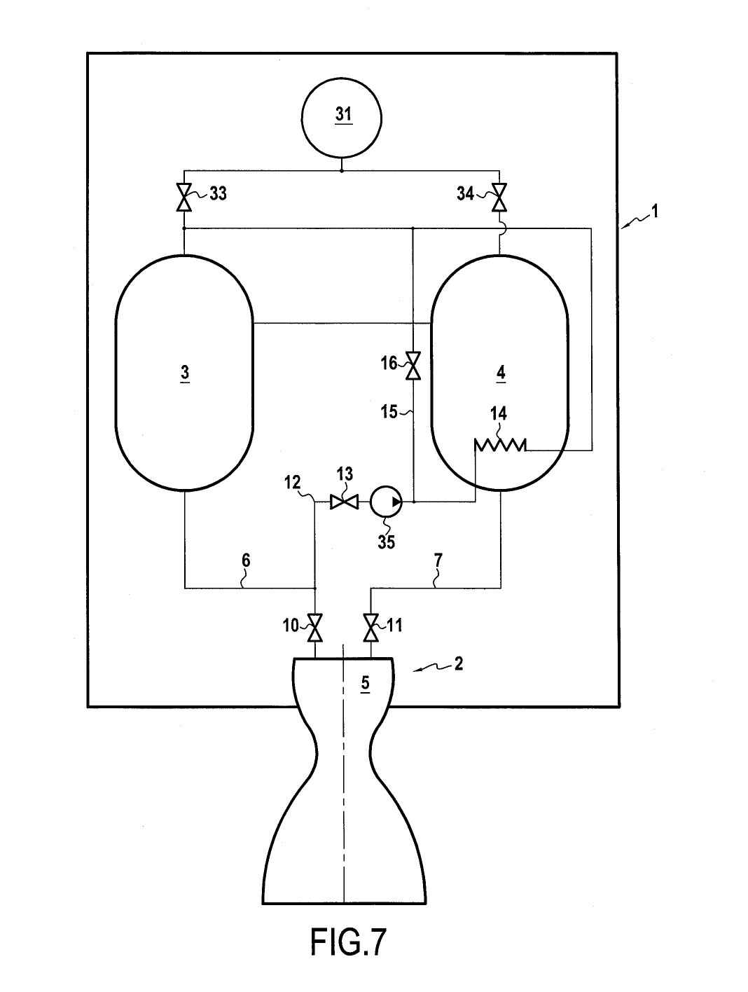

Thus, in a fifth embodiment shown in FIG. 7, and analogous to the first embodiment, the pumps are replaced by a tank 31 of pressurized gas, e.g. helium, that is connected to the propellant tanks 3 and 4 via respective valves 33 and 34. Thus, in operation, the pressure of the helium in the pressurization gas tank 31 pushes the propellants via their respective feed circuits 6 and 7 to the thrust chamber 5. In order to make it possible for the hydrogen bled via the branch 12 to be reinjected in the gaseous stage into the top of the first tank 3, the branch 12 includes a forced flow device 35 upstream from the heat exchanger 14 and from the bypass duct 15. In this embodiment, since the second feed circuit 7 does not include a pump downstream from the second tank 4, preventing cavitation is no longer a priority, in contrast to compensating for any heating of the second propellant in the second tank 4. Consequently, in this embodiment, the heat exchanger 14 is not situated in an outlet funnel from the second tank 4, but may be situated more centrally in the second tank 4 so as to be more effective in cooling the volume of the second propellant that is contained in the second tank. Other elements of this vehicle 1 are essentially equivalent to those of the first embodiment, and they are given the same reference numbers, even though this embodiment of the second feed circuit 7 does not include a return branch leading to the top of the second tank 4.

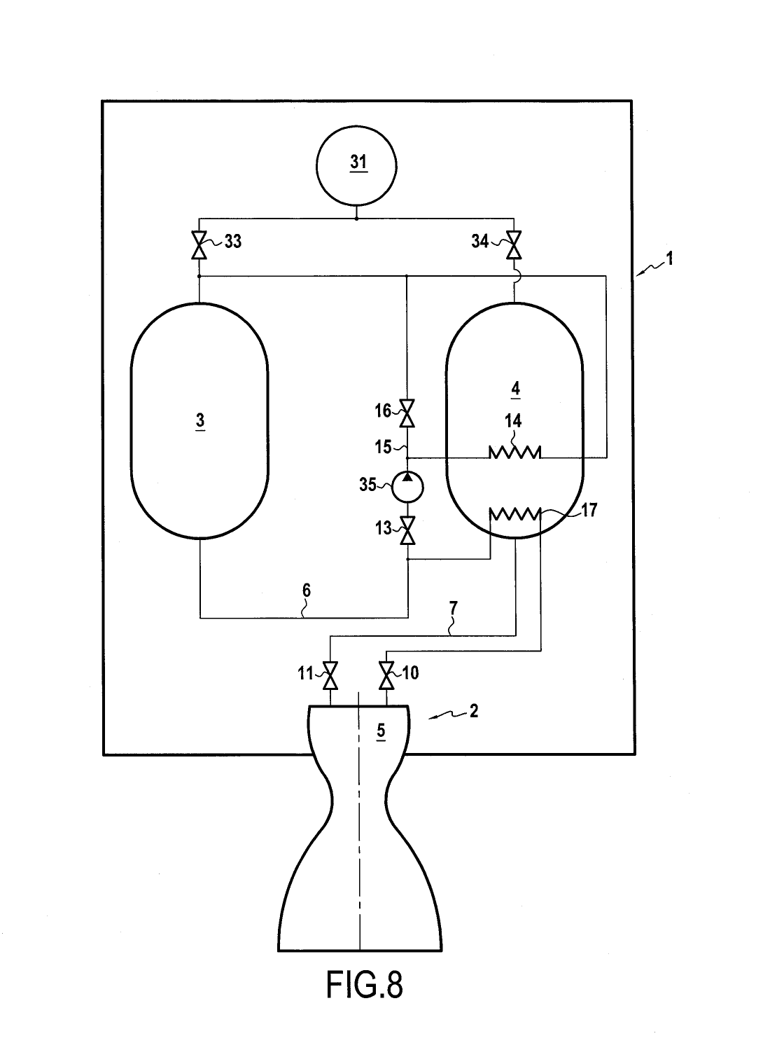

In a sixth embodiment shown in FIG. 8 and essentially analogous to the second embodiment, the pumps of the second embodiment are likewise replaced by a tank 31 of pressurized gas, e.g. helium, that is connected to the propellant tanks 3 and 4 via respective valves 33 and 34. As in the fifth embodiment, a forced flow device 35 upstream from the heat exchanger 14 and the bypass duct 15 ensures a return flow of the first propellant via the branch 12 to the first tank 3. The heat exchangers 14 and 17 may likewise be situated within the second tank 4 rather than in an outlet funnel. The other elements of this vehicle 1 are essentially equivalent to those of the second embodiment, and they are given the same reference numbers, even though this embodiment of the second feed circuit 7 does not include a return branch leading to the top of the second tank 4.

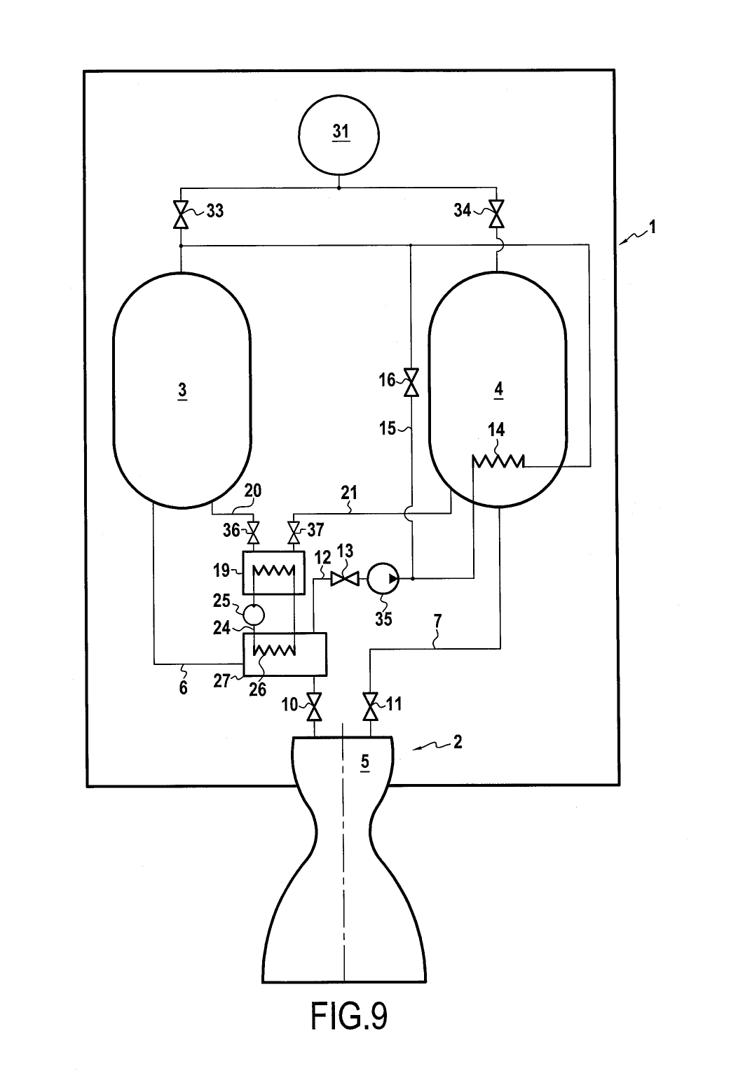

In a seventh embodiment shown in FIG. 9 and essentially analogous to the fourth embodiment, the pumps of this second embodiment are likewise replaced by a tank 31 of pressurized gas, e.g. helium, that is connected to the propellant tanks 3 and 4 via respective valves 33 and 34. The pressurization of the propellants in the tanks 3 and 4 also makes it possible to omit micropumps for feeding the fuel cell 19 with propellants, and in this embodiment this feed is regulated by variable flow valves 36 and 37 in the circuits 20 and 21. As in the fifth and sixth embodiments, a forced flow device 35 upstream from the heat exchanger 14 and from the bypass duct 15 serves to ensure the return flow of the first propellant through the branch 12 to the first tank 3. The heat exchanger 14 may likewise be situated within the second tank 4 rather than in an outlet funnel. The other elements of this vehicle 1 are essentially equivalent to those of the fourth embodiment, and they are given the same reference numbers, even though this embodiment of the second feed circuit 7 does not include a return branch to the top of the second tank 4.

Although the present invention is described above with reference to specific embodiments, it is clear that various modifications and changes may be undertaken on those embodiments without going beyond the general scope of the invention as defined by the claims. In addition, individual characteristics of the various embodiments described may be combined in additional embodiments. Thus, by way of example, in a variant of the seventh embodiment, the vehicle could incorporate a branch for reinjecting the second propellant in the gaseous phase into the second tank, as in the first four embodiments, using a forced flow device for this second propellant in the gaseous phase. Consequently, the description and the drawings should be considered in a sense that is illustrative rather than restrictive.

1. A system for feeding a rocket engine with propellants, the system comprising:
a first tank;
a second tank;
a first feed circuit connected to the first tank for feeding a first liquid fuel to the rocket engine and including, downstream from said first tank, a branch passing through a first heat exchanger incorporated in the second tank; and
a second feed circuit connected to the second tank for feeding a second liquid propellant to the rocket engine, the second liquid propellant having a saturation point substantially higher than the first liquid propellant;
wherein said branch is also connected to said first tank downstream from the first heat exchanger.

2. The feed system according to claim 1, wherein the second feed circuit includes a pump.

3. The feed system according to claim 1, wherein said branch further includes a bypass duct bypassing said first heat exchanger.

4. The feed system according to claim 1, wherein said feed circuit includes a pump upstream from said branch.

5. The feed system according to claim 1, wherein said branch includes a forced flow device.

6. The feed system according to claim 1, wherein said first heat exchanger is incorporated in an outlet funnel from the second tank.

7. The feed system according to claim 1, wherein the first circuit further includes at least one second heat exchanger incorporated in the second tank.

8. The feed system according to claim 7, wherein said second heat exchanger is incorporated in an outlet funnel from the second tank.

9. The feed system according to claim 8, wherein said first circuit further includes a third heat exchanger incorporated in the second tank, upstream from the second heat exchanger.

10. The feed system according to claim 1, wherein the first feed circuit further includes, upstream from said branch, another heat exchanger suitable for being connected to a heat source.

11. The feed system according to claim 10, wherein said first feed circuit further includes a buffer tank, said other heat exchanger being incorporated in said buffer tank.

12. A method of feeding a rocket engine with liquid propellants, the method comprising the following steps:
extracting a flow of a first liquid propellant from a first tank through a first feed circuit;
bleeding a portion of said flow of the first liquid propellant through a branch of the first feed circuit;
passing the first liquid propellant bled through said branch into the gaseous state in a heat exchanger incorporated in a second tank containing a second liquid propellant at a temperature higher than the saturation temperature of the first liquid propellant in the branch; and
extracting a flow of the second liquid propellant from the second tank via a second feed circuit.

13. The feed method according to claim 12, wherein at least a portion of the first liquid propellant bled through said branch is reinjected in the gaseous state into the first tank.

14. A feed method according to claim 12, wherein the first liquid propellant is liquid hydrogen and the second liquid propellant is liquid oxygen.
